(19) United States
(12) Patent Application Publication
(10) Pub. No.: US 2025/0214728 A1
(43) Pub. Date: Jul. 3, 2025

(54) SYSTEM AND METHOD FOR PACKAGING AND STORING DRY ICE

(71) Applicant: S.D. Enterprises Inc. an Iowa Corporation DBA, Scott Ales Inc. in Florida., Eustis, FL (US)

(72) Inventor: Scott ALES, Eustis, FL (US)

(73) Assignee: S.D. Enterprises Inc. an Iowa Corporation DBA, Scott Ales Inc. in Florida., Eustis, FL (US)

(21) Appl. No.: 19/003,950

(22) Filed: Dec. 27, 2024

Related U.S. Application Data
(60) Provisional application No. 63/615,637, filed on Dec. 28, 2023.

(51) Int. Cl. B65B 25/00; B65B 1/06; B65B 1/22; B65B 55/00; F25C 5/20

(52) U.S. Cl. CPC B65B 25/00; B65B 1/06; B65B 1/22; B65B 55/00; F25C 5/24

(57) ABSTRACT

Systems and methods are provided for filling containers with dry ice, where a dry ice generator and a container are configured to be connected via a passage that connects the outlet of the generator and the inlet of the container such that during a transfer of the dry ice from the generator into the container, the passage prevents humidity or moisture from entering the container during the transfer, while, for example by means of at least one one-way escape valve, air, gas, humidity, or moisture are allowed to exit the container.

This application claims priority to prior U.S. Provisional Patent Application No. 63/615,637, filed May Dec. 28, 2023, the entire contents of which is incorporated herein by reference.

### BACKGROUND OF DISLOSURE

### 1. Field of Disclosure

The present disclosure relates to methodologies and devices for packaging, transporting, and storing of dry ice.

### 2. Description of Related Art

Conventional dry ice production facility illustrated in FIG. 1 typically uses a loose shroud system 12 as an attempt to maintain quality of dry ice pallets 14 as they exit palletizer 10 and drop into a rectangular container 16. However, such conventional systems do little to minimize moisture content, or otherwise control the environment, of dry ice pallets as they exit the palletizer for subsequent delivery to customers.

Accordingly, there is a need for a device or system that can remove as much humidity (moisture) from the dry ice production process as possible, and/or address at least the above-noted environmental control drawbacks associated with conventional dry ice production systems and methodologies.

### SUMMARY OF THE DISCLOSURE

Example embodiments may address at least the above problems and/or disadvantages and other disadvantages not described above. Also, example embodiments are not required to overcome the disadvantages described above, and may not overcome any of the problems described above.

Exemplary embodiments of the present disclosure provide a system that can comprise a dry ice generator including an outlet outputting dry ice, a container including an inlet for receiving dry ice, a passage connecting the outlet and the inlet during a transfer of the dry ice from the generator into the container, the passage preventing humidity or moisture from entering said container during said transfer, and at least one one-way escape valve allowing air, gas, humidity, or moisture to exit said container.

According to exemplary implementations of disclosed exemplary embodiments, the system can further comprising a dehumidifier connected to the container for reducing moisture or humidity in the container.

According to further exemplary implementations of disclosed exemplary embodiments, the dehumidifier can be a desiccant dehumidifier connected to the container via a flexible tubing to pump dry air into the container.

According to still further exemplary implementations of disclosed exemplary embodiments, the passage between the inlet and the outlet can comprise a spout that connects the outlet to the inlet.

According to yet further exemplary implementations of disclosed exemplary embodiments, the container can comprise a cylindrical interior volume and the inlet can be configured at an upper portion of such volume.

In exemplary implementations of disclosed exemplary embodiments, the system can also comprise a lid with an interior conical volume configured to accommodate a conical shape of the dry ice extending above a rim of the cylindrical interior volume.

In further exemplary implementations of disclosed exemplary embodiments, the container can comprise a flexible material, and the system can comprise a rigid enclosure configured to accommodate said container.

In exemplary implementations of disclosed exemplary embodiments, the outlet of the dry ice generator can comprise extrusion holes and said dry ice exiting the outlet can comprise pellets.

In further exemplary implementations of disclosed exemplary embodiments, the passage between the outlet and the inlet can comprise a vent to allow escape of access gas passing via the passage. For example, an external system can be configured for receiving the escaped access gas and converting the escaped access gas to a liquid for processing by the dry ice generator.

In exemplary implementations of disclosed exemplary embodiments, the system can also comprise a vibratory base configured with respect to the container to facilitate leveling and/or settling of dry ice received in the container.

According to exemplary implementations of disclosed exemplary embodiments, the container can comprise a second opening for accessing an interior volume of the container.

According to exemplary implementations of disclosed exemplary embodiments, a removable clamp can be used to connect the inlet of the container to the outlet of the dry ice generator, or to the spout if one is provided.

Exemplary embodiments of the present disclosure provide a filling method that comprises providing a passage between an inlet of a container to an outlet of a dry ice generator for filling the container with dry ice generated by the dry ice generator, forcing a low humidity air to enter said container to substantially fill said container with the low humidity air, allowing an excess of the low humidity air to exit the container through a one-way valve when filling the container with dry ice, when the container is substantially filled with dry ice, disconnecting the inlet of the container from the outlet of the dry ice generator, sealing the inlet of the container, and, after sealing, allowing sublimated CO2 gas to escape out of the container, while preventing humid air from entering the container.

According to exemplary implementations of the disclosed exemplary embodiments, the filling method can also comprise preventing the container from over pressurizing during the filling of the container by venting a gas from the passage between the inlet and the outlet when the dry ice generator is generating dry ice

According to exemplary implementations of the disclosed exemplary embodiments, the filling method can further comprise converting the gas vented from the passage to a liquid for input to the dry ice generator.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein

FIG. 1 is an illustrative of a conventional dry ice production facility illustrated.

FIG. 2 is a perspective diagrammatical view of a system according to exemplary embodiments of the present disclosure.

FIG. 3A is a perspective diagrammatical view of a system according to exemplary implementation of exemplary embodiments of the present disclosure.

FIGS. 3B, 3C, 3D, and 3E are enlarged perspective diagrammatical views of various components of a system according to exemplary implementation of exemplary embodiments of the present disclosure illustrated in the example of FIG. 3A.

FIG. 4 is a diagrammatical block illustration of certain components of a system according to exemplary embodiments of the present disclosure.

FIG. 5 is a diagrammatical block illustration of certain conventional system components.

FIG. 6 is a perspective diagrammatical view of a system according to another exemplary implementation of exemplary embodiments of the present disclosure.

FIG. 7A is a perspective diagrammatical view of a component of systems according to exemplary implementations of exemplary embodiments of the present disclosure.

FIGS. 7B and 7C are diagrammatical views of systems according to exemplary embodiments of the present disclosure implementing a component illustrated in the example of FIG. 7A.

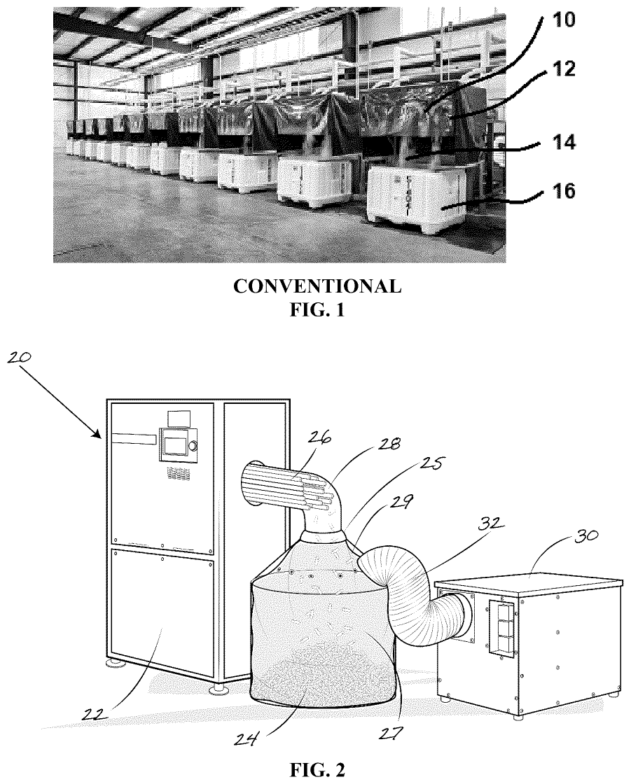

Other objects, advantages and salient features of the disclosure will become apparent to those skilled in the art from the details provided, which, taken in conjunction with the annexed drawing figures, disclose exemplary embodiments of the disclosure.

### DETAILED DESCRIPTION OF EXEMPLARY EMBODIMENTS

The matters defined in the description such as a detailed construction and elements are provided to assist in a comprehensive understanding of the embodiments of the disclosure and are merely exemplary. Accordingly, those of ordinary skill in the art will recognize that various changes and modifications of the embodiments described herein can be made without departing from the scope and spirit of the disclosure.

Exemplary embodiments of the present disclosure will now be described in detail with reference to the annexed drawings. In the following description, a detailed description of known functions and configurations incorporated herein has been omitted for clarity and conciseness. Specific dimensions of various components provided in, or implied by, the drawings are to facilitate understanding of exemplary embodiments of the present disclosure.

Referring to FIG. 2, exemplary embodiments of the present disclosure provide devices and systems that facilitate removing or lowering humidity (moisture) at the production process of dry ice. According to an exemplary implementation of disclosed embodiments, system 20 includes a dry ice generator 22 that produces dry ice 27 (for example a pelletizer 22 that produces dry ice in the form of solid pallets), where the dry ice 27 is output via outlet 26 of generator 22 and transferred into container 24 through inlet 25 of container 24. Optionally, snout 28 can be provided between outlet 26 and inlet 25 to facilitate the transfer of dry ice from generator 22 into container 24. According to exemplary embodiments of the disclosure, the passage, connecting outlet 26 and inlet 25 during the transfer of dry ice from generator 22 into container 24 is sealed, at least during the transfer, to prevent humidity or moisture from entering container 24.

According to an exemplary implementation, container 24 includes one or more one way escape valves 29 that allow moisture and/or air and/or gas to exit container 24, for example during the transfer of dry ice from generator 22 into container 24.

According to another exemplary implementation, system 20 can include a dehumidifier 30, such as a desiccant dehumidifier, which can be connected, for example via a flexible tubing 32, to container 24 to pump dry air, for example essentially zero humidity air, into container 24 thereby eliminating or at least reducing moisture or humidity in container 24. As container 24 is filled with dry ice transferred from generator 22, the dry air could escape via one way valve(s) or port(s) 29 such that the filled container 24 would have essentially no moisture/humidity, or at least a reduced amount thereof.

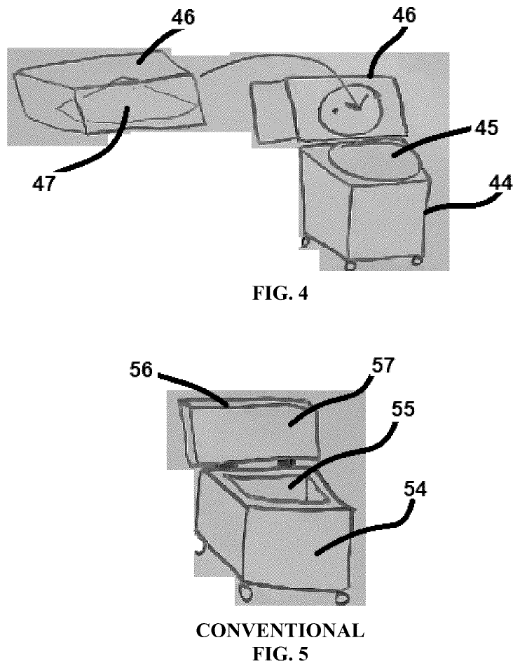

According to another exemplary implementation, referring to FIG. 4, a container 44 is provided with a cylindrically shaped interior volume 45, whereby as the product flows into the cylindrical volume 45 a more even distribution of a product, such as dry ice pallets, is achieved along the interior wall surface compared to a conventional rectangular or square interior shape 55 of a conventional container 54 (see FIG. 5). According to yet further exemplary implementation, container 44 can comprise a lid 46 with an interior conical volume 47 to accommodate a conical shape of product mound extending above rim of volume 45 when volume 45 is filled, such that when lid 45 is closed the recess cone 47 in the lid 46 can easily closed the top of the container by essentially corresponding to the form of the top of the product in the filled container (in contrast to a conventional lid 56 (FIG. 5) whose flat bottom surface 57 would not properly seal the top of a filled container 44.

According to yet another exemplary implementation, container 24 can be a flexible container, such as a plastic bag, or comprise a flexible insert or liner, where an exemplary methodology of filling a container with dry ice according to embodiments of the present disclosure includes:
Forcing low or zero humidity air to enter container 24 such that container 24 expands (for example like a balloon), substantially completely filling container 24 with the low or zero humidity air.
Allowing excess low or zero humidity air to exit container 24 through the one-way valve(s) or port(s) 29 when filling container 24.
When container 24 is substantially completely filled with dry ice, disconnecting inlet 25 of container 24 from outlet 26 of generator 22 (or from snout 28 if included) and sealing inlet 25.
After sealing container 24, allowing sublimated CO2 gas to escape container 24 through the one-way valve(s) or port(s) 29.
Not allowing humid air to enter container 24 at least due to the above-described methodology.

According to disclosed system and methodology, a concept is to create a container 24 with controlled space with one way low pressure release valve(s) to eliminate added or additional humidity, or moisture of any kind from degrading or coming into contact with dry ice or solid CO₂ particles inside that given space.

In an exemplary implementation of the disclosed embodiments, once the containment device, such as container 24, is sealed and/or closed, only off gasses can release as they are created from the sublimation of dry ice to a gas form. No foreign gases, air, or additional molecules can enter the container in any way, such that any additional or outside molecules are prevented from coming into contact with the solid CO₂/dry ice particles while remaining inside the container 24 with the space fully contained and sealed, save for the outward released CO₂ gas.

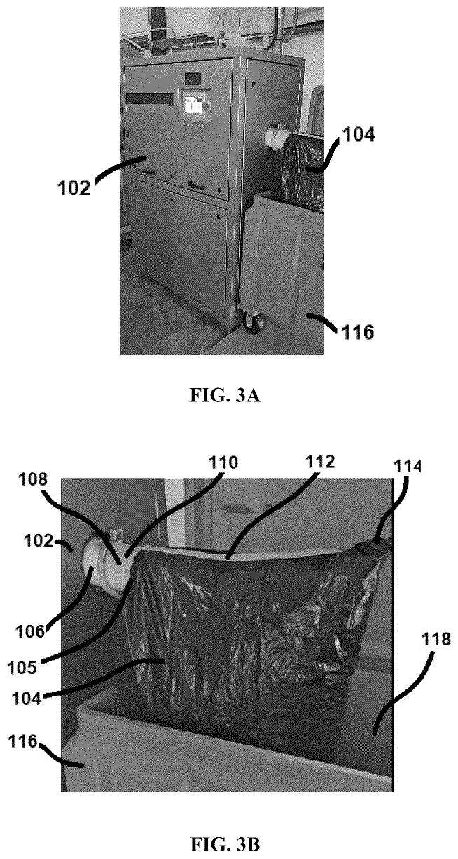

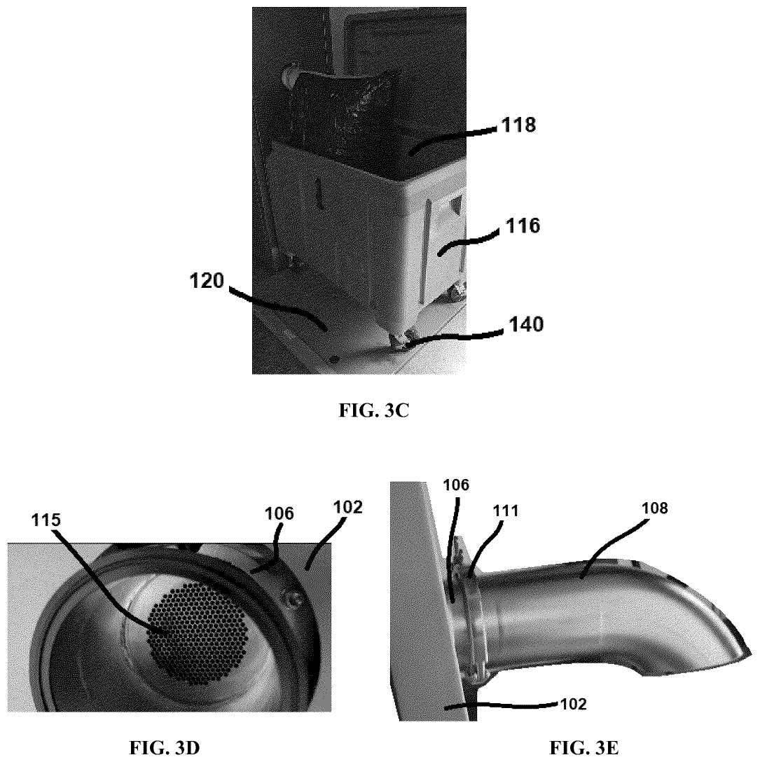

Referring to FIGS. 3A-3E, according to an exemplary implementation of disclosed embodiments a system 20 can comprise a flexible container or lining 104 disposed inside a storage space/volume 118 of a bin or rigid enclosure 116. Inlet/first opening 105 of container 104 can be removably attached to an outlet 106 of a system producing dry ice, such as a pelletizer, 102 where outlet 106 includes extrusion holes 115 (see, for example, FIG. 3D). In an exemplary implementation, a delivery snout 108 can be attached to outlet 106, for example using a mechanical clamp 111 to seal around the snout (see, for example, FIG. 3E). In an example implementation, inlet 105 can be removably attached to outlet 106, or if used a snout 108.

According to an exemplary implementation, container 104 can comprise a plastic bag, for example and without limitation a 4 mil plastic bag.

According to yet another exemplary implementation, container 104 can comprise a second opening 114 for readily accessing the content of the container (for example, the dry ice store in the container). In an exemplary implementation, second opening 114 can be selectively opened and closed/sealed by a closure mechanism 112 such as a ZipLock (patent expired), or a sealing tape. For example, first opening 105 and second opening 114 can be implemented as a single opening corresponding portions of which can be selectively sealed or opened during filling of container 104 with dry ice, venting of, or removing moisture from, container 104, and accessing of dry ice within container 104. Such a single opening can be disposed across the entire length of a top of container 104, and the closure mechanism 112 can provide a seal across the entire length at the top of container 104 to prevent ambient air from coming into contact with the dry ice but allow the end user to access the product when needed. For example, container 104 can include one or more one-way gaseous valves to prevent the pressurization of the bag while maintaining a protective seal from humidity or any foreign air from entering the bag until closure mechanism 12 is opened to access content of container 104.

According to a further exemplary implementation of the embodiments of the present disclosure, container 104 can be collapsed by evacuating air from container 104, for example via a portion of resalable opening 114, for example and without limitation container 104 can comprise a 100 gallon bag that can be vacuum pulled to collapse to less than 5% volume. Then, for example, a dry ice pelletizer 102 can be turned on to deposit sublimating dry ice into the container 104 sealably connected to outlet 106, or spout 108, causing container 104 to expand, where the previously collapsed state of container 105 can prevents, for example and without limitation approximately 90% of, the nearby or ambient humidity from contacting the solid particles inside container 104. One or more one way valves allows for sublimating CO₂ gas to escape from container 104 facilitating prevention of a rupture or breach in the material of container 104.

According to still further exemplary implementation of the embodiments of the present disclosure, a vibratory base 120 (for example, disposed under bin 116 or container 104, as shown without limitation in the example of FIG. 3C) can be configured to facilitate leveling and/or settling of dry ice pellets in container 104 during the filling process, which can also facilitate the dry ice to settle and become more dense. The removal of gas/air from such improved filling of container 104 can provide further benefits for the transportation and life of the product in container 104. Yet further possible benefit, is the increased density of product inside the same volume or space within container 104.

In exemplary implementation of the embodiments of the present disclosure, once container 104 is filled to a desired level, container 104 can be moved laterally via wheels 140 under the bin 116 of container 104 which can allow an operator easier access to container 104, for example to seal the fill opening or inlet 105, for example and without limitation with the tape strip, or with a Ziploc. Container 104 can still include one or more one way valves, for example on the top of container 104 and/or for example proximate to sealed opening 105 and/or 114, to continue allowing the sublimating CO₂ gas to escape as needed.

Still further exemplary implementation of the embodiments of the present disclosure provide an exhaust/relief vent configured to facilitate preventing the receiving container from over pressurizing (in an extreme case, potential from exploding) while loading dry ice and recapturing the excess CO₂ gas created when producing the dry ice. As illustrated in a non-limiting example of FIG. 6, a vent 63 can be configured between outlet 106/26 and inlet 105/25, to allow allows for capturing the excess CO₂ gas, as dry ice is being made, which can also facilitate preventing the bag from being over pressurized during the filling process. For example vent 63 can be in a form of a hollow pipe or tube (for example and without limitation forming an about three-inch diameter vent), for example welded at a top of snout 108/28, appearing for example and without limitation as a “T” pointing upward. According to exemplary non-limiting implementations, such a vent element can improve the efficiency of making the dry ice. In yet further exemplary implementation, any incremental amount of CO₂ gas can be run through an external system which, for example, can convert the gas back into a liquid to be run through the dry ice maker later, which can potentially create substantial long term savings overall.

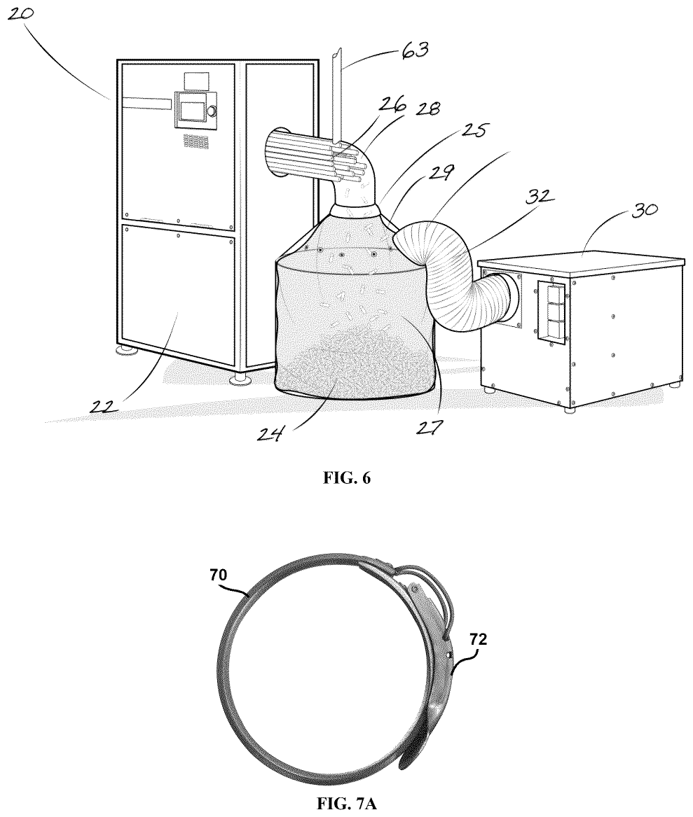

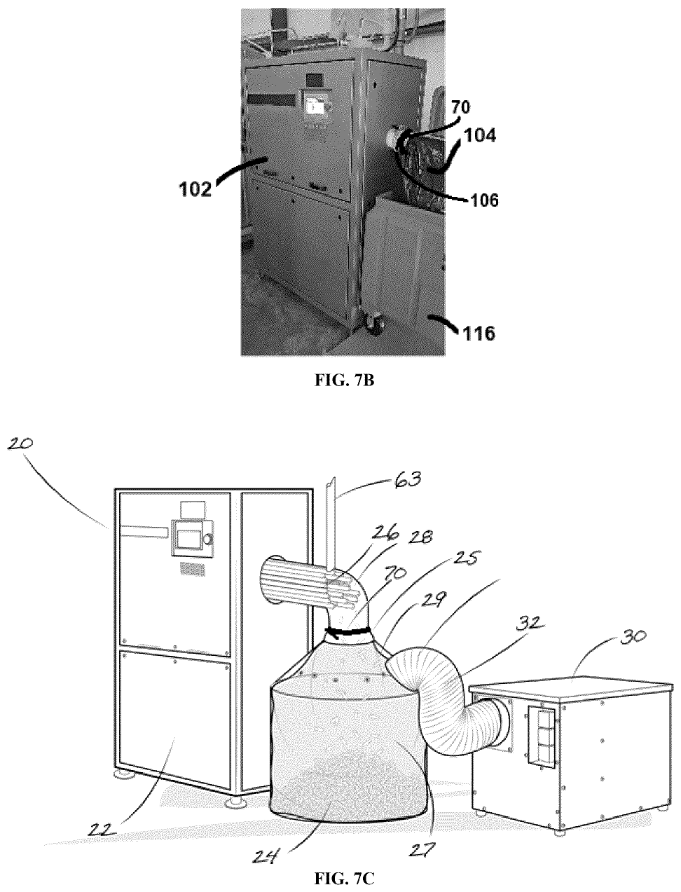

Another exemplary implementation of the embodiments of the present disclosure provides a structure for an attachment point of container 24 or lining 104 to outlet 106/26 or snout 108/28. For example, as illustrated in non-limiting examples of FIGS. 7A-7C, inlet 105/25 of container 104/24 can be removably sealed to the snout 108/28 (or to outlet 106/26 in a case where snout 10/28 is not used) during the filling process with a metal spring clip 70 comprising for example a closure/release mechanism 72. For example, when the container 104/24 is determined to be full, the removable spring clip 70 allows container 104/24 to be detached and closed, for example by a seal across the top of the container 104/24.

The following exemplary, non-limiting advantages are potentially achievable by systems and methodologies according to example embodiments of the present disclosure:
a substantial (for example, 50-75% less) reduction in ambient air, humidity, or water molecules from coming into contact with the freshly made dry ice;
preserving the integrity of the dry ice as it moves from the pelletizer to the bag/container, for example by implementation of one way valve(s);
more efficient distribution of filling material, for example by implementation of a vibration table;
a simplified construction of a container, for example by implementation of a re-sealable, such as a Ziplock, seals, for example for either or both the filling snout access and the access across the top of container
reducing contamination of dry ice by applying vacuum to remove to less than 5% of the contaminated or humid air remaining in container prior to filling.

Additional non-limiting potential benefits of systems and methodologies

according to exemplary disclosed embodiments include without limitation implementation of gas recovery units which can improve the conversion rate of liquid CO₂ to dry ice. For example, without a recovery system in place, the gas by-product of making dry ice is vented outside. With a recovery system, the conversion rate of 2.3 to 1 drops to 1.4-1. By sending the gas from the container while loading through the system according to exemplary embodiments of the present disclosure, the recovery rate would improve, even if by some small percentage. Thereby making a process according to exemplary disclosed embodiments even more valuable to an entity filling the containers.

Without limitation, overall benefits of systems and methodologies according to exemplary disclosed embodiments can include:
Better product with substantially less moisture content.
More density of filled product improving volume shipping and less sublimation rate due to density.
Potential additional savings when using recovery systems.
Ability to control the working environment where containers are filled by reducing the amount of gas escaping from the loading process of open systems, thereby controlling the working environment to safe levels that reduce requirement for venting the facility, thus allowing AC or Heat to stay on inside the facility.

While the present disclosure has been shown and described with reference to certain exemplary embodiments thereof, it will be understood by those skilled in the art that various changes in form and details may be made therein without departing from the spirit and scope of the present disclosure.

1. A system comprising:
a dry ice generator including an outlet outputting dry ice;
a container including an inlet for receiving dry ice;
a passage connecting said outlet and said inlet during a transfer of said dry ice from said generator into said container, said passage preventing humidity or moisture from entering said container during said transfer; and
at least one one-way escape valve allowing air, gas, said humidity, or said moisture to exit said container.

2. The system of claim 1, further comprising a dehumidifier connected to said container for reducing said moisture or said humidity in said container.

3. The system of claim 2, wherein said dehumidifier is a desiccant dehumidifier connected to said container via a flexible tubing to pump dry air into said container.

4. The system of claim 1, wherein said passage comprises a spout connecting said outlet to said inlet.

5. The system of claim 1, wherein said container comprises a cylindrical interior volume and said inlet is configured at an upper portion of said volume.

6. The system of claim 5, further comprising a lid with an interior conical volume configured to accommodate a conical shape of said dry ice extending above a rim of said cylindrical interior volume.

7. The system of claim 1, wherein said container comprises a flexible material.

8. The system of claim 7, further comprising a rigid enclosure configured to accommodate said container.

9. The system of claim 1, wherein said outlet comprise extrusion holes and said dry ice exiting said outlet comprises pellets.

10. The system of claim 1, wherein said passage comprises a vent to allow escape of access gas passing via said passage.

11. The system of claim 10, further comprising an external system receiving said escaped access gas and converting said escaped access gas to a liquid for processing by said dry ice generator.

12. The system of claim 1, further comprising a vibratory base configured with respect to said container to facilitate leveling and/or settling of said dry ice received in said container during said transfer.

13. The system of claim 7, wherein said container comprises a second opening for accessing an interior volume of said container.

14. The system of claim 1, further comprising a removable clamp connecting said inlet to said outlet.

15. A filling method comprising:
providing a passage between an inlet of a container to an outlet of a dry ice generator for filling said container with dry ice generated by said dry ice generator;
forcing a low humidity air to enter said container to substantially fill said container with said low humidity air;
allowing an excess of said low humidity air to exit said container through a one-way valve when filling said container with dry ice;
when said container is substantially filled with said dry ice, disconnecting said inlet of said container from said outlet of said dry ice generator;
sealing said inlet of said container; and.
after said sealing, allowing sublimated CO₂ gas to escape out of said container, while preventing humid air from entering said container.

16. The filling method of claim 15, wherein said container comprises at least one one-way valve, and said one-way valve providing said escape and said preventing.

17. The filling method of claim 15, further comprising preventing said container from over pressurizing during said filling of said container by venting a gas from said passage when said dry ice generator is generating said dry ice.

18. The filling method of claim 17, further comprising converting said gas vented from said passage to a liquid for input to said dry ice generator.
